(19) United States
(12) Patent Application Publication
(10) Pub. No.: US 2009/0122045 A1
(43) Pub. Date: May 14, 2009

(54) Power Source Display Apparatus, Power Source Display Method, and Electronic Apparatus

(75) Inventor: Eiji Shibata, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/242,602

(22) Filed: Sep. 30, 2008

(30) Foreign Application Priority Data
Nov. 9, 2007 (JP) 2007-292427

(51) Int. Cl. G09G 5/00

(52) U.S. Cl. 345/211

(57) ABSTRACT

According to one embodiment, a power source display apparatus is provided with a main power source switch, a power source display module, an Illumination performing decorative illumination display when lighted up, a setting module for setting whether or not the illumination should be caused to conduct decorative illumination display, and a control module being lit up only one of the power source display module and the illumination according to set state of the setting module when the main power source switch is in the on-state.

### CROSS-REFERENCE TO RELATED APPLICATIONS

This application is based upon and claims the benefit of priority from Japanese Patent Application No. 2007-292427, filed Nov. 9, 2007, the entire contents of which are incorporated herein by reference.

### BACKGROUND

1. Field

One embodiment of the present invention relates to an improvement of a power source display apparatus which displays the on/off state of a power source, a power source display method, and an electronic apparatus.

2. Description of the Related Art

As is well-known, for example, in a home electronic apparatus typified by an AV (audio visual) apparatus such as a television broadcast receiver or an optical disc recording and reproducing apparatus, a power source switch and a power source display module are provided in an apparatus main body thereof so that a user is caused to recognize a power-on state of a power source during an on-state of the power source switch by lighting up the power source display module.

On the other hand, in such an electronic apparatus, apparatuses whose design performances have been improved by providing illuminations on the apparatus main bodies thereof are spreading in recent years. That is, design performance of an electronic apparatus during operating or service time of the electronic apparatus is improved by the decorative illumination effect thereof obtained by lighting up an illumination during operating time of the electronic apparatus.

Now, in an electronic apparatus provided with an illumination in this manner, when a power source display module and the illumination are simultaneously lit up during operating time of the apparatus, such a case may occur that display conducted by the power source display module interferes with decorative illumination effect obtained by the illumination so that improvement of design performance cannot be achieved.

Jpn. Pat. Appln. KOKAI Publication No. 2002-354363 discloses a system which, when a power indicator of a video apparatus confuses a viewer, selectively lights up a light source for lighting up the power indicator, where a power source button is selectively set to be lighted up or turned off, for example, during the on-state of a power source.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a front view for explaining an appearance of a television broadcast receiver according to one embodiment of the present invention;

FIG. 2 is a block diagram for explaining a signal processing system of the television broadcast receiver according to the embodiment;

FIG. 3 is a diagram for explaining one example of a display switching screen displayed on the television broadcast receiver according to the embodiment;

FIG. 4 is a diagram for explaining control on a power source display module and an illumination performed in the television broadcast receiver according to the embodiment;

FIG. 5 is a flowchart for explaining a processing operation for controlling the power source display module and the illumination performed in the television broadcast receiver according to the embodiment; and

FIG. 6 is a front view for explaining a modification example of the television broadcast receiver according to the embodiment.

### DETAILED DESCRIPTION

Various embodiments according to the invention will be described hereinafter with reference to the accompanying drawings. In general, according to one embodiment of the invention, a power source display apparatus is provided with a main power source switch, a power source display module, an illumination performing decorative illumination display when lighted up, a setting module for setting whether or not the illumination should be caused to conduct decorative illumination display, and a control module being lit up only one of the power source display module and the illumination according to set state of the setting module when the main power source switch is in the on-state.

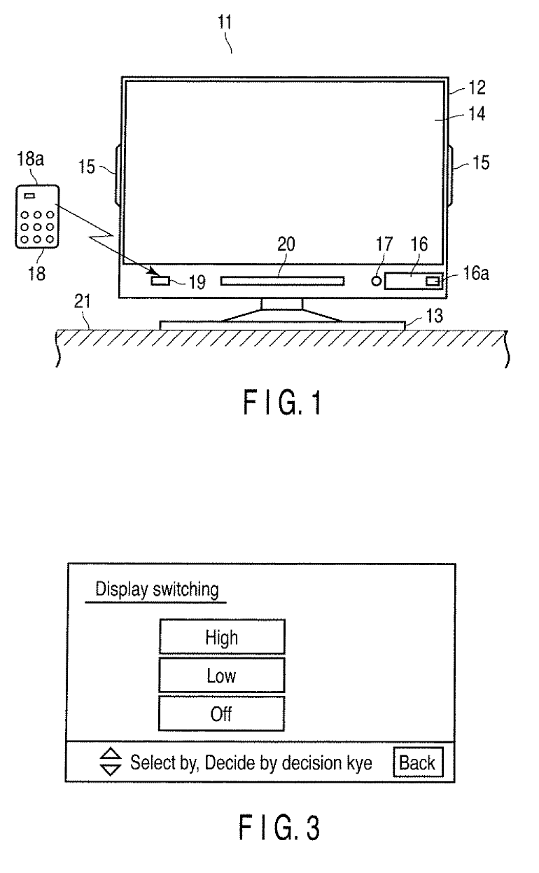

One example of the present invention will be explained in detail below with reference to the drawings. FIG. 1 shows a state of a television broadcast receiver 11 for explaining the example viewed from its front side. The television broadcast receiver 11 mainly comprises a thin cabinet 12, and a support stand 13 supporting the cabinet 12.

In the cabinet 12 of these members, a video (image) display module 14 comprising a flat panel type display provided with, for example, a liquid crystal display panel or the like is arranged at a front central portion thereof. In the cabinet 12, speakers 15, 15 are disposed on both side faces thereof so that stereo audio reproduction can be performed.

Further, in the cabinet 12, an operation module 16 including a main power source switch 16a, a power source display module 17, a receiving module 19 for receiving operation information wirelessly transmitted from a remote controller 18 including a power source switch 18a, and an illumination 20 are disposed on a front lower portion.

The illumination 20 comprises, for example, a plurality of light emitting diodes (LEDs) (not shown) arranged in a horizontal direction, where decorative illumination display is performed by lighting up each LED. Incidentally, the power source switch 18a on the remote controller 18 is set to serve when the main power source switch 16a is in the on-state.

On the other hand, the support stand 13 is coupled to a bottom central portion of the cabinet 12 such that the cabinet 12 can be freely rotated, and it is configured to support the cabinet 12 in a standing manner in a state that the support stand 13 is placed on a horizontal surface of a predetermined base stand 21.

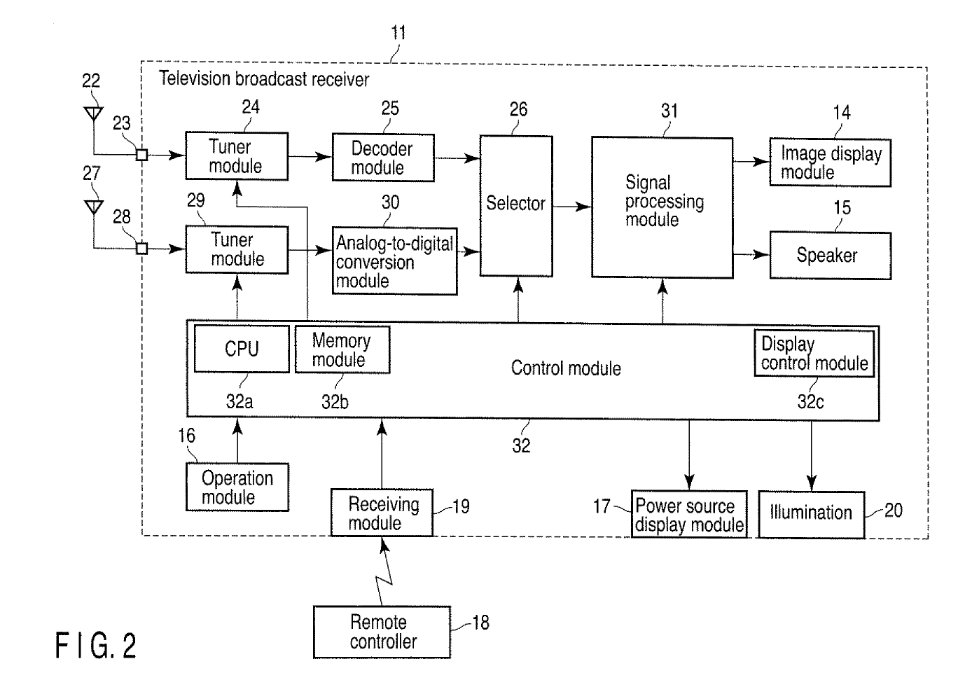

FIG. 2 schematically shows a signal processing system of the television broadcast receiver 11. In FIG. 2, reference numeral 22 denotes an antenna for digital television broadcast reception. A digital television broadcast signal received by the antenna 22 is supplied to a tuner module 24 via an input terminal 23.

The tuner module 24 selects a signal of a desired channel from the input digital television broadcast signal. After a signal output from the turner module 24 is supplied to a decoder module 25 to be subjected to, for example, MPEG (moving picture experts group) 2 decode processing, which is supplied to a selector 26.

An analog television broadcast signal received by an antenna 27 for analog television broadcast reception is supplied to a tuner module 29 via an input terminal 28. The tuner module 29 selects a signal of a desired channel from the input analog television broadcast signal. After a signal output from the tuner module 29 is digitized by an analog-to-digital conversion module 30, which is output to the selector 26.

The selector 26 selects one digital signal from respective digital signals output from the decoder module 25 and the analog-to-digital conversion module 30 to supply the selected one to a signal processing module 31. The signal processing module 31 performs a predetermined signal processing on a digital image signal contained in the input signal to output the same to the image display module 14 and cause the image display module 14 to conduct video display. The signal processing module 31 performs a predetermined signal processing on a digital audio signal contained in the input signal to output the same to the speakers 15 and cause the speakers 15 to conduct audio reproduction.

Here, in the television broadcast receiver 11, its various operations including the various signal receiving operations mentioned above are integrally controlled by the control module 32. The control module 32 includes a central processing unit (CPU) 32a therein and receives operation information from the operation module 16 or operation information transmitted from the remote controller 18 and received by the receiving module 19 to control respective modules so as to reflect contents of the operations, respectively.

In this case, the control module 32 utilizes a memory module 32b. The memory module 32b mainly includes a read-only memory (ROM) storing a control program which the CPU 32a executes therein, a random access memory (RAM) for supplying a working area to the CPU 32a, and a non-volatile memory in which various setting information, control information, and the like are stored.

The control module 32 is connected with the power source display module 17 and the illumination 20, respectively. Lighting up and turning off of the power source module 17 and the illumination 20 are controlled by a display control module 32c of the control module 32. Incidentally, regarding the illumination 20, such a configuration is adopted that a user can selectively set whether or not the illumination 20 conducts decorative illumination display thereof, namely, whether the illumination 20 is lit up or turned off in advance.

The setting can be performed by a user according to such an operation that the user operates a menu key (not shown) of the remote controller 18 to enter a menu screen having a hierarchical structure and reach a display switching screen such as shown in FIG. 3 and selects one of items “High”, “Low”, and “OFF” using a cursor key and decide the same by a decision key on the screen thereof.

In this case, the display control module 32c is set such that, when the item “High” is set, the illumination 20 is lit up with a predetermined first luminance, when item “Low” is set, the illumination 20 is lit up with a second predetermined luminance lower than the first luminance, and when the item “OFF” is set, the illumination 20 is turned off.

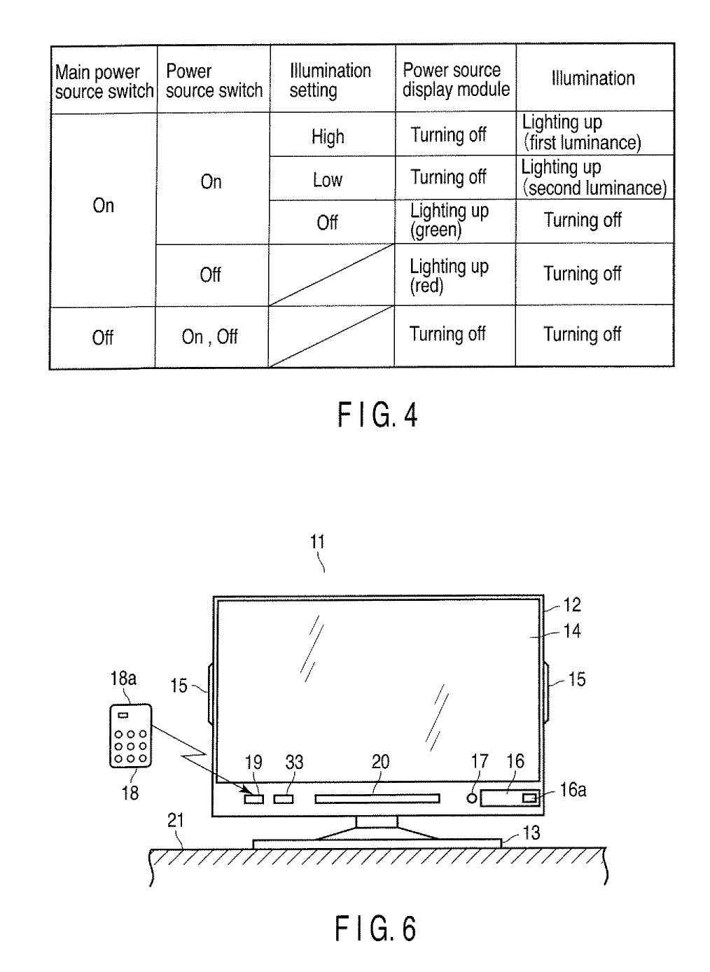

As shown in FIG. 4, the display control module 32c controls the power source display module 17 and the illumination 20 based upon the on/off state of the main power source switch 16a of the operation module 16, the on/off state of the power source switch 18a of the remote controller 18, and set state of the illumination 20.

That is, when the main power source switch 16a of the operation module 16 is in the off-state, the television broadcast receiver 11 is put in stopped state regardless of the on/off state of the power source switch 18a of the remote controller 18. At this time, image display according to the image display module 14 and audio reproduction according to the speakers 15 are not performed, and the display control module 32c conducts control so as to turn off both the power source display module 17 and the illumination 20.

When the main power source switch 16a of the operation module 16 is operated to the on-state and the power source switch 18a of the remote controller 18 is operated to the on-state, the television broadcast receiver 11 is put in driven state so that image display according to the image display module 14 and audio reproduction according to the speakers 15 are performed.

At this time, when the set state of the illumination 20 conducted by a user is “High” or “Low”, the display control module 32c is lit up the illumination 20 with luminance corresponding to the set state and is turned off the power source display module 17. When the set state of the illumination 20 conducted by a user is “OFF”, the display control module 32c is turned off the illumination 20 and is lit up the power source display module 17 with green color.

Further, when the main power source switch 16a of the operation module 16 is operated to the on-state and the power source switch 18a of the remote controller 18 is operated to the off-state, the television broadcast receiver 11 is put in standby state so that image display according to the image display module 14 and audio reproduction according to the speakers 15 are not conducted. At this time, the display control module 32c is turned off the illumination 20 and is lit up the power source display module 17 with red color.

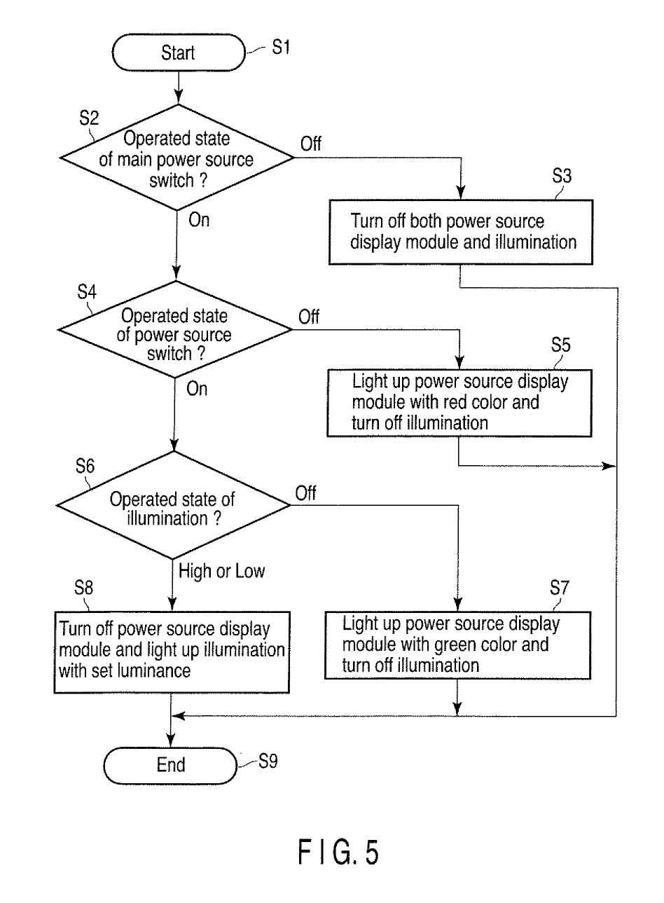

FIG. 5 is a flowchart showing a processing operation for controlling the power source display module 17 and the illumination 20 described above collectively. That is, when a processing is started (Step S1), the display control module 32c makes determination about the operated state of the power source switch 16a of the operation module 16 at Step S2 and when it is determined that the power source switch 16a is in the off-state, the display control module 32c is turned off both the power source display module 17 and the illumination 20 at step S3 and terminates the processing (Step S9).

When it is determined that operated state of the main power source switch 16a is in the on-state at the Step S2, the display control module 32c makes determination about the operated state of the power source switch 18a of the remote controller 18 at Step S4, and when it is determined that the power source switch 18a is in the off-state, the display control module 32c is turned off the illumination 20 and is lit up the power source display module 17 with red color at Step S5 to terminate the processing (Step S9).

Further, when it is determined that the operated state of the power source switch 18a is in on-state at the Step S4, the display control module 32c determines the set state of the illumination 20 at Step S6, and when it is determined that the set state is in “OFF”, the display control module 32c is turned off the illumination 20 and is lit up the power display source module 17 with green color at Step S7 to terminate the processing (Step S39).

When it is determined that the set state of the illumination 20 is “High” or “Low” at the Step S6, the display control module 32c is lit up the illumination 20 with luminance corresponding to the set state of the illumination 20 and is turned off the power source display module 17 at Step S8 to terminate the processing (Step S9).

According to the embodiment, control is performed such that, in such a state that decorative illumination display is performed by the illumination 20, when both the main power source switch 16a of the operation module 16 and the power source switch 18a of the remote controller 18 are operated to the on-state, the illumination 20 is lighted up and the power source display module 17 is turned off, and in such a state that decorative illumination display is not performed by the illumination 20, when both the switches 16a and 18a are operated to the on-state, the illumination 20 is turned off and the power source display module 17 is lighted up.

That is, in driven state where both the main power source switch 16a and the power source switch 18a are in the on-state, only one of the power source display module 17 and the illumination 20 is lighted up based on the set state of the illumination 20 but both thereof are not lighted up simultaneously.

Therefore, a user can recognize that the main power source switch 16a is in the on-state from such a fact that one of the power source display module 17 and the illumination 20 is lighted up. Since the power source display module 17 and the illumination 20 are not lighted up simultaneously, even if both thereof are arranged in proximity to each other, display according to the power source display module 17 is prevented from interfering with decorative illumination effect obtained by the illumination 20, so that the decorative illumination effect of the illumination 20 can be further highlighted.

Thus, by performing effective lighting up control to the power source display module 17 and the illumination 20, it is made possible to achieve display of the on/off state of the power source display module 17 and decorative illumination effect obtained by the illumination 20 effectively, respectively.

As shown in FIG. 6, a sensor 33 for detecting brightness of the surrounding area of the cabinet 12 is provided at a front lower portion of the cabinet 12, so that the set state of the illumination 20 can be automatically changed according to the detection result from the sensor 33.

That is, by conducting automatic control such that, when it is determined by the sensor 33 that the surrounding area is bright, the illumination 20 is lighted up with luminance corresponding to the set state of “High”, but when it is determined by the sensor 33 that the surrounding area is dark, the illumination 20 is lighted up with luminance corresponding to the set state of “Low”, the illumination 20 is prevented from interfering with display image so that excellent image display can be performed.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power source display apparatus comprising:
a main power source switch configured to be selectively operable to on-state and the off-state;
a power source display module configured to be selectively controllable to lighted-up state and turned-off state;
an illumination configured to be selectively controllable to lighted-up state and turned-off state and conduct decorative illumination display when lighted up;
a setting module configured to set whether or not the illumination should be caused to perform decorative illumination display; and
a control module configured to light up only one of the power source display module and the illumination according to set state of the setting module when the main power source switch is in the on-state.

2. The power source display apparatus according to claim 1, wherein
the control module
conducts control such that, when the main power switch is in the on-state and the setting module is set so as to cause the illumination to conduct decorative illumination displays the power source display module is turned off and the illumination is lit up, and
conducts control such that, when the main power switch is in the on-state and the setting module is set so as not to cause the illumination to conduct decorative illumination display, the power source display module is lit up and the illumination is turned off.

3. The power source display apparatus according to claim 1, wherein
the control module conducts control such that both the power source display module and the illumination are turned off, when the main power source switch is in the off-state.

4. The power source display apparatus according to claim 1, further comprising
a power source switch configured so as to be selectively operable to the on-state and the off-state and function in the on-state of the main power source switch, wherein
the control module
conducts control such that, when both the main power source switch and the power source switch are in the on-state and the setting module is set so as to cause the illumination to conduct decorative illumination display, the power source display module is turned off and the illumination is lit up,
conducts control such that, when both the main power source switch and the power source switch are in the on-state and the setting module is set so as not to cause the illumination to conduct decorative illumination display, the power source display module is lighted up with first color and the illumination is turned off, and
conducts control such that, when the main power source switch is in the on-state and the power source switch is in the off-state, the power source display module is lighted up with second color different from the first color and the illumination is turned off.

5. The power source display apparatus according to claim 1, wherein
when the setting module is set so as to cause the illumination to conduct decorative illumination display, the setting module can set luminance of the illumination at a lighting-up time of the illumination.

6. The power source display apparatus according to claim 5, wherein
the setting module can selectively set luminance at a lighting-up time of the illumination to a predetermined first luminance and a second luminance lower than the first luminance.

7. An electronic apparatus comprising:
a receiving module configured to receive a signal;
a signal processing module configured to produce and output an image signal by performing a predetermined signal processing to a signal received in the receiving module;
a main power source switch configured to be selectively operable to the on-state and the off-state;
a power source display module configured to be selectively controllable to lighted-up state and turned-off state;
an illumination configured to be selectively controllable to lighted-up state and turned-off state and conduct decorative illumination display when lighted up;
a setting module configured to set whether or not the illumination should be caused to perform decorative illumination display; and
a control module configured to conduct control such that, when the main power source switch is in the on-state and the setting module is set so as to cause the illumination to conduct decorative illumination display, the power source display module is turned off and the illumination is lit up, and when the main power source switch is in on-state and the setting module is set so as not to cause the illumination to conduct decorative illumination display, the power source display module is lit up and the illumination is turned off.

8. The electronic apparatus according to claim 7, further comprising
a display module configured to perform image display based upon an image signal obtained in the signal processing module.

9. A power source display method comprising:
method of controlling a power source display apparatus including:
a main power source switch configured to be selectively operable to the on-state and the off-state;
a power source display module configured to be selectively controllable to lighted-up state and turned-off state;
an illumination configured to be selectively controllable to lighted-up state and turned-off state and conduct decorative illumination display when lighted up; and
a setting module configured to set whether or not the illumination should be caused to perform decorative illumination display, wherein:
when the main power source switch is in the on-state and the setting module is set so as to cause the illumination to conduct decorative illumination display, the power source display module is turned off and the illumination is lit up; and
when the main power source switch is in the on-state and the setting module is set so as not to cause the illumination to conduct decorative illumination display, the power source display module is lit up and the illumination is turned off.
